(19) United States
(12) Patent Application Publication
(10) Pub. No.: US 2025/0001344 A1
(43) Pub. Date: Jan. 2, 2025

(54) AIR FILTER HAVING FRAME WITH SENSORS AND STACKABLE DISPOSABLE FILTER ELEMENTS

(71) Applicant: WOOSH AIR INC., San Francisco, CA (US)

(72) Inventor: Winston MOK, San Francisco, CA (US)

(21) Appl. No.: 18/679,902

(22) Filed: May 31, 2024

Related U.S. Application Data
(60) Provisional application No. 63/524,056, filed on Jun. 29, 2023.

(51) Int. Cl. B01D 46/52; B01D 46/00

(52) U.S. Cl. CPC B01D 46/526; B01D 46/0009

(57) ABSTRACT

The current application relates to an air filter that reduces the cost of air-filters by separating the filter element into multiple stackable and disposable sections of a same standardized shape and size. The filter elements may be inserted into a unique, reusable filter frame that includes sensors and communication capability. The filter sections and the frame are made such that the filter sections inserted into the frame to align to and fit into each of the uniform frame sections securely and without air leakage. Shipping and storing the filter sections are made easy by size and shape standardization, enabling them to be stacked one on top of the other so that the filter folds fit into each other as they are stacked, making shipping and storing economical. The frame itself is made from hard plastic and the sensors and communication module are attached to the frame.

### PRIORITY CLAIM

The present disclosure claims benefit of and priority to U.S. Provisional Ser. No. 63/524,056, filed Jun. 29, 2023. The contents of that application are hereby incorporated by reference in their entirety.

### TECHNICAL FIELD

The present disclosure relates generally to air filters. More particularly, aspects of this disclosure relate to an air filter system that includes a replaceable frames and filter elements that may be compactly stored.

### BACKGROUND

1″ thick filters are the most common thickness in the US currently; however, 3-5″ thick filter designs are growing in popularity as they offer more surface area for filtering and require less maintenance, changing every 6-12 months versus 1 to 3 months.

As more and more HVAC systems are moving to the thicker filter standard, it also reduces the energy required to move air through the air handler and lower maintenance; however the filters are higher cost-2 to 4 times the 1″ filter cost.

### SUMMARY

The term embodiment and like terms are intended to refer broadly to all of the subject matter of this disclosure and the claims below. The disclosed embodiments are identified as examples only. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the detailed description section below. This summary is not intended to identify key or essential features of the claimed subject matter; nor is it intended to be used in isolation to determine the scope of the claimed subject matter. The subject matter should be understood by reference to appropriate portions of the entire specification of this disclosure, any or all drawings and each claim. Additional aspects of the disclosure will be apparent to those of ordinary skill in the art in view of the detailed description of various embodiments, which is made with reference to the drawings, a brief description of which is provided below.

One disclosed example is a stackable air filter element including a filter material having central surface area in a pleated pattern. The air filter element includes edges on the sides of the central surface area allowing the filter element to be supported by a filter frame. The pleated pattern is configured to be aligned with the pleated pattern of another air filter element to allow stacking of the air filter element with another air filter element.

In another disclosed implementation of the example air filter element, the air filter element includes at least one cutout. The cutout is configured to be aligned with a magnetic closure system of the filter frame. In another disclosed implementation, the cutout is configured to be aligned with an opening of a differential pressure sensor system of the filter frame. In another disclosed implementation, the edges of the filter element engage with the filter frame to support the filter element and create a seal against air leaks when the filter element is inserted within the filter frame and the filter frame is latched closed.

Another disclosed example is a reusable air filter frame that includes a filter frame bottom defined by a plurality of support sections that are enabled to hold a replacement filter element in place within the filter frame bottom. A filter frame top is connected by hinges to one of the plurality of support sections on one side of the filter bottom. The filter frame top is enabled to be closed and latched to another of the plurality of support sections on the opposite side of the filter frame bottom to close the reusable air filter frame with the replaceable filter element within the reusable filter frame.

In another disclosed implementation of the example reusable air filter frame, the replaceable filter element within the closed and latched reusable filter frame is supported on all sides by the plurality of support sections of the filter frame bottom. In another disclosed implementation, the latched closed filter frame is enabled to create an airtight seal around the replaceable filter element within the filter frame. In another disclosed implementation, the plurality of support sections of the filter frame bottom comprise at least a horizontal divider or rib and at least a vertical divider. In another disclosed implementation, the replaceable filter element includes filter folds that are configured to be supported from distortion during use by additional support elements attached to the filter frame bottom. In another disclosed implementation, a depth of the filter frame bottom is configured to be the same depth of the replaceable filter element inserted therein. In another disclosed implementation, the reusable filter frame is configured to hold one or more replaceable filter elements during use. In another disclosed implementation, the filter frame is configured to hold a plurality of sensors, at least one control module, and at least one communication module. The communication module is communicably coupled to the sensors. The communication module is connected to an external communication system. In another disclosed implementation, the plurality of sensors comprise a differential pressure sensor affixed to one of the plurality of supports of the frame bottom. The differential pressure sensor is enabled to sense a filtered air pressure at an outlet of an air filter. The filter frame further includes a manifold extending into the incoming air stream enabled to sense the air pressure at an inlet to the air filter to arrive at a differential pressure for air of the filter. In another disclosed implementation, the plurality of sensors further include at least an air temperature sensor and at least an air humidity sensor. In another disclosed implementation, the air temperature sensor enables a control of the filtered air temperature by an HVAC system using the air filter. In another disclosed implementation, the air humidity sensor enables a control of the filtered air humidity by an HVAC system using the air filter. In another disclosed implementation, the differential pressure sensor and the controller together are enabled to set an initial baseline differential pressure for the air filter each time the replaceable filter element is replaced in the reusable filter frame. In another disclosed implementation, the communication module is enabled to indicate the requirement for a filter element change to a consumer based on the differential air pressure change of the air filter. In another disclosed implementation, the communication module is enabled to provide air quality data external to the air filter for data storage.

Another disclosed example is a reusable air filter system including a replaceable air filter element being a stackable filter element having a plurality of pleated folds in a central region. The air filter element has edges around the central region enabled to support the replaceable filter element within the reusable air filter frame. A pleated fold of a first replaceable filter element is configured to align with the pleated fold patten of another replaceable filter element, enabling stacking of the replaceable filter elements for storage and shipping. A reusable air filter frame includes a closable and latchable bottom section and a top section. The closed and latched reusable filter frame is enabled to hold the replaceable filter elements securely therein and provide an air tight seal around the replaceable filter element during operation of the filter system. The system has sensors including a differential air pressure sensor, an air temperature sensor, and an air humidity sensor. A communication module is enabled to provide at least a disposable filter replacement indication and an air quality information to a consumer and a storage device. A control module is enabled to generate a base line differential pressure value for a replaced disposable filter and generate a replacement indication for the disposable filter based on differential pressure change that is provided to the consumer.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is an exemplary drawing of the air filter in accordance with one aspect of the invention.

FIG. 2 show various views (FIG. 2.1 to FIG. 2.4) of the exemplary stackable filter elements/panels (1) in accordance with one aspect of the invention.

FIG. 2.1 shows a side view of the exemplary filter element (1).

FIG. 2.2 shows a top view of the exemplary filter element (1).

FIG. 2.3 shows the exemplary filter element (1) and a stack of the exemplary filter elements (1).

FIG. 2.4 shows the stacking of filter elements (1).

FIG. 3 shows the details of an exemplary frame top (2) in accordance with one aspect of the invention.

FIG. 3.1, FIG. 3.2 and FIG. 3.3 are all side views of the exemplary frame top (2) in accordance with aspects of the invention.

FIG. 4 shows the details of an exemplary filter frame bottom (3) in accordance with one aspect of the invention.

FIG. 4-1, FIG. 4.2 and FIG. 4.3 are all side views of the exemplary frame bottom (3) in accordance with aspects of the invention.

FIG. 5 shows the exemplary filter frame in the hinged open state in accordance with one aspect of the invention.

FIG. 6 shows the exemplary filter frame latched closed with the filter elements/panels (1) loaded inside in accordance with one aspect of the invention.

FIG. 7 shows the details of the typical placement of the magnets on filter frame bottom and the input into the differential pressure sensor manifold on filter frame in accordance with one aspect of the invention.

FIG. 7.1 shows the placement of closure magnet (14) at location A on the bottom horizontal divider (16) in accordance with one aspect of the invention. It also shows the sensor input of the sensor manifold at location A on the horizontal.

FIG. 7.2 shows the placement of closure magnet (14) at location B on the bottom horizontal divider (16) in accordance with one aspect of the invention.

FIG. 7.3 shows the placement of closure magnet (14) at location A on the bottom horizontal divider (16) in accordance with one aspect of the invention.

FIG. 7.4 shows the location D on the filter frame top (2) in accordance with one aspect of the invention. It shows the detail placement of the strike plate (4) adjacent the sensor clearance hole (6) for the pressure sensor manifold.

FIG. 8 shows the detail of the typical communication and differential sensor module (19) attachment to the back of the horizontal divider (16) of the filter frame bottom (3) in accordance with one aspect of the invention.

FIG. 8.1 shows the communication and differential sensor module (19) in accordance with one aspect of the invention.

FIG. 8.2 shows the differential pressure manifold (18) on the horizontal divider (16) of the filter frame bottom (3) in accordance with one aspect of the invention.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present application describes an invention that helps to reduce the cost of air-filter by separating the filter element into multiple stackable sections of same size, that are disposable, to be inserted into unique, reusable filter frame that comprise all the sensors and communication capability. The filter sections, and the frame are made such that the filter sections inserted into the frame align to and fit into each of the uniform frame sections that are designed to hold the filter sections.

The filter sections are standardized for shape and size, and the filter frame is designed to accept the standardized filter elements. The filter elements have cut out sections where magnetic strike plates are placed for the frame closure and a sensor clearance holes where differential pressure sensors are situated on the assembled frame.

The filter frame, as indicated above has magnetic closure capability with magnets and strike plates on the top of the frame that engage with strike plates on the bottom section of the frame such that the frame can be held closed once the filter elements are in place prior to engaging the mechanical latches on the sides of the frame assembly. Though the magnetic closure capability may be used to hold the filters in place within the filter frame prior to mechanical latched closure, other methods may be used, including, for example, holding the filter within the filter frame with or without the filter frame being closed using mechanical latches as well as other techniques.

The frame is typically made of hard plastic for ease of manufacture and reduced cost. The frame holds the differential pressure sensor, the communication module, other sensors for monitoring temperature, humidity etc., and the power supply module.

Shipping and storing the filter sections to be inserted into the filter frame are made easy by size and shape standardization, based on the frame segmentation, enabling them to be stacked one on top of the other so that the filter folds fit into each other as they are stacked, making the space required for shipping and storing smaller than that for the plurality of filters sections individually.

Unique features of the example disclosed filter elements include for example:
1. Use of multiple size standardized filter elements (1″ to 5″) inserted within a unique filter frame making up a single air filter.
2. The standardized filter elements have cutouts at the edges to enable closure magnets and air pressure sensor to be fixed on the filter frame without obstruction.
3. The filter elements are made with sealable edges that seal and prevent air leak when inserted within the frame.
4. The filter elements are pleated to have the maximum surface area for air to flow through when in use, thereby improving the efficiency of air flow and reducing the need for frequent filter change.
5. The standardized (depth of 1″ to 5″) replaceable filter elements enable stacking with filter pleats fitting one within the other reduce the total space required for storage of the filter elements and for shipping the filter elements to the consumer.
6. The reusable filter frame with latchable top and bottom sections with the top holding all sensors and electronics.
7. The re-usable filter frame segmented to hold a plurality of filter elements securely during operation.
8. The re-usable filter frame bottom depth optimized for the filter size to be used (e.g., 1″ to 5″).
9. Preferred latching using magnets to hold the reusable filter frame closed during operation without air leakage around the filter elements.
10. Having a differential pressure sensor attached to the reusable filter frame.

The following are reference terms and acronyms, definitions and use details for the disclosure.

Filter: The filter comprises a filter element made from a filter material fitted securely within a filter frame to filter and purify the air flowing through the HVAC system.

Filter element section: Manufactured standardized filter segment (irrespective of the thickness, e.g., 1″ to 5″, that fits into the associated frame section. The filter element sections are disposable and replaceable.

The sections are standardized to stack with the filter folds of the upper filter element section aligning to and fitting into the filter folds of the filter element section below for ease of transport. Cut outs are implemented on the filter elements for allowing access for magnets and magnetic strike plates to come together on the filter frame and hold the filter frame closed are provided.

The sections have the necessary edge cutouts for magnetic closure and for the differential pressure sensor as standard.

The disposable filter element has edge seals that engage with the filter frame edges to ensure an airtight seal.

Reusable Filter frame: A reusable filter frame typically made to fit specific standard sizes of the HVAC equipment and the size of the filter element is used. The filter frame may be made of hard plastic to reduce cost and to make manufacturing easy. The reusable filter frame is made in two sections: a filter frame top and a frame bottom. The filter frame top is attached by hinges to the frame bottom enabling the filter frame to be closable. The filter frame top and bottom also comprise latching capability such that the closed filter frame is securely latchable with the disposable filter elements within the reusable filter frame. The frame bottom section is configured to hold drop in replacement of the filter elements. The reusable filter frame is enabled to hold the filter elements securely during operation without air leaks around the edges of the filter elements. The filter top and bottom have magnetic closure capability with strike plates attached to the filter frame, top and magnets attached to the filter frame bottom for temporary closure of the filter before the latches are engaged. Though shown in figures with magnets attached to the filter frame bottom and strike plates attached to the filter frame top, the alternate arrangement with magnets attached to the filter frame top and strike plate attached to the filter frame bottom will also allow the temporary magnetic closure of the reusable filter frame.

The filter frame top provides the necessary support to the filter element and seals the element in, preventing leakage of air around the filter element. It carries sensors and electronic circuits that comprise at least a differential air pressure sensor and other such as, temperature and humidity sensors, communication module, sensor change indicator, sensor and communication circuits power-on/off switches that operate when the blower is operational and any other sensors that are installed. It may carry all necessary sensors and electronic circuits. Installation of these features on the reusable frame (and not the disposable filter elements) reduces the cost of the filter replacement as these sensors and electronic circuits are reused.

The example disposable filter element and reusable filter frame have a series of advantages including:

Lower manufacturing and shipping costs—Known filters are expensive to ship because they are bulky. By reducing the size by a factor of ˜4× and eliminating the need for a cardboard frame, wire backing and strong adhesives, the example stacked replacement filter modules may be made and shipped significantly cheaper.

Ease of installation—The reusable frame and filter module work together to make a simple drop-in installation procedure. Filter modules come stacked and just need to be separated and dropped into the reusable frame. Closing the top of the reusable frame secures and seals the filter modules in the reusable frame.

Safe disposal—After the filter modules are dirty, they can simply be re-stacked to trap the dust and contaminants and easily disposed of in any garbage. This is unlike known cardboard filters that have cardboard and metal support, which often need to be crushed to fit most garbage bins due to their large size.

Environmental friendliness—The stacking filter modules use less material than traditional cardboard filters because they leverage the reusable frame and don't require any additional cardboard and wire backing structures. The example modules also use less adhesives than known filters.

Lower operational cost—Making the reusable filter frame with hard plastic reduces its cost of manufacture. Also, as the filter frame holds all sensors, communication and power modules as replacable but reusable modules, the cost of the replaceable filter is reduced, reducing the operation cost of using the air filter.

Ease of maintenance—Since the sensors, communication and power supply modules are attached to the reusable frame, it is easy to maintain the system and replace the modules on failure. This, unlike the prior art systems with sensors attached to the filter elements, results in lower overall cost for system operation and maintenance.

The reusable filter frame has advantages as follows:

The filter frames are designed to work together with filter elements of 1″ to 5″ thickness while providing case of installation/filter element change as well as support the filter element during operation.

By having all the necessary sensors, such as differential air pressure sensor, air temperature sensor, air humidity sensor, etc. attached to the reusable frame and not the filter element, the sensor element cost is reduced while providing the capability to monitor the air quality.

The air temperature sensor allows an HVAC system using the air filter to monitor and control the temperature of the filtered air. The air humidity sensor allows the HVAC system using the filter to control the humidity of the filtered air for the comfort of the users.

The differential air pressure on the frame is able to establish a baseline for differential pressure and indicate the need for filter element change based on the differential air pressure change.

The communication module on the filter frame is enabled to indicate and communicate the need for filter change to a consumer and to a data storage external to the filter system. The air quality and differential pressure data collected by the various sensors are also sent by the communication module to the consumer and to the data storage. The stored data is usable for review and analysis of the filter system operation. Thus, the data stored relates to the air quality and filter performance information over time. The stored information may include data such as particle counts on the incoming and filtered air, the temperature of the filtered air, humidity of the filtered air and other sensed information on the operation of the filter. The differential pressure changes over time. This stored information in external storage such as the cloud provides a clear picture of the operation of the filter under different climatic conditions for an operator.

Use of a power switch on the frame activated based on air flow through the filter element or through a signal on activation of the blower of an HVAC system using the air filter is able to turn on or off the sensors and the communication module to conserve power.

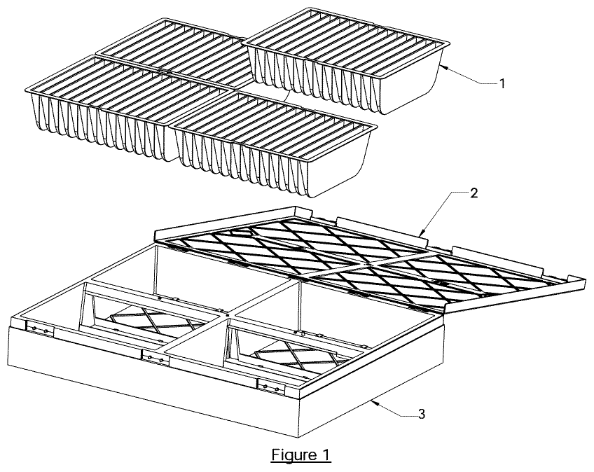

The following are reference numbers in FIGS. 1-8:
1. Filter element; also described as filter panel
   1-1. Four stack of filter elements/filter panels
   1-2. Three stack of filter elements/filter panels
2. Filter frame top
3. Filter frame bottom
4. Strike plate on filter frame top
5. Latch attached to filter frame top
6. Sensor clearance hole on filter frame top
7. Hinges attached to filter frame top
8. Horizontal rib on filter frame top
9. Top Cross bars on filter frame top
10. Vertical rib on filter frame top
11. Hinge snap on filter frame bottom
12. Latch snap on filter frame bottom
13. Bottom cross bar on filter frame bottom
14. Magnets on filter frame bottom
15. Vertical dividers on filter frame bottom
16. Horizontal divider or horizontal rib on filter frame bottom
17. Bottom differential pressure sensor hole on filter frame bottom
18. Sensor manifold on filter frame bottom
19. Differential pressure sensor and communication module
20. Step Joint

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

FIG. 1 shows the filter in accordance with one aspect of the invention. The stackable disposable filter elements/panels (1) are made with a filter material and has standardized shape and size to fit the reusable frame segment. The reusable frame has a top section (2) and a segmented bottom section (3).

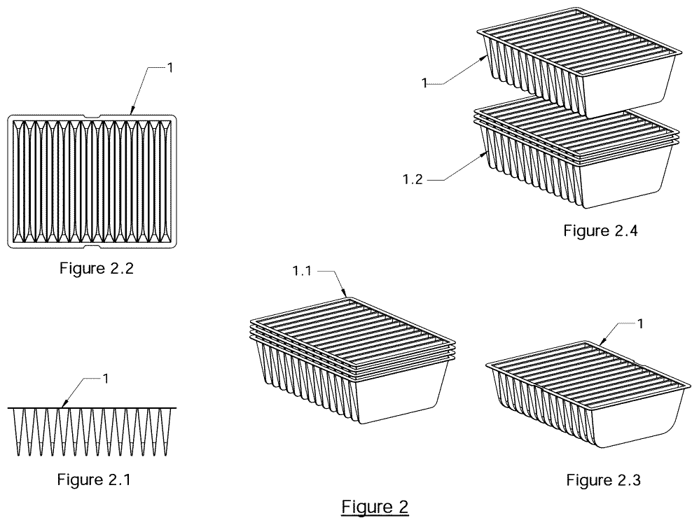

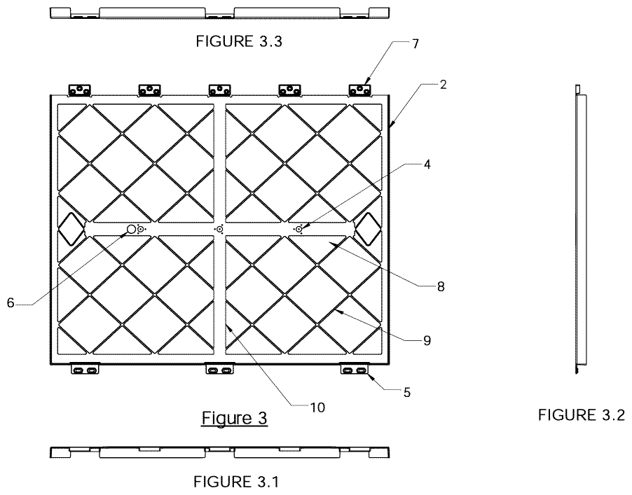

FIG. 2 shows the various views of the stackable disposable filter elements/panels (1). FIG. 2.1 shows the filter folds as a side view of filter element/panel (1). FIG. 2.2 shows the top view of the filter element/panel (1) that includes the standardized cutout for magnetic closure/strike plate and differential pressure sensor module. FIG. 2.3 shows the stacking of the individual filter element/panel (1) by aligning the filter folds, so that the filter elements are stacked one within the other. FIG. 2-3 shows a four stack filter element (1.1) that is shippable or storable. FIG. 2.4 shows the method of stacking the filter element/panel (1) by aligning the filter folds. A three-stack filter element/panel (1) is shown as (1.2).

The large filter elements/panels (1) will be provided with additional structural elements (not shown) as part of the filter element/panel (1) itself or the filter frame (2 & 3) to support and maintain the shape of the filter element during pressurized air flow during operation. The typical support will be metal strings or plastic/metal strips that are attached to the sides of the filter frame bottom to provide support to the folds of the filter element.

FIG. 3 shows the details of the typical frame top (2). The three side views of the filter frame top are shown in FIG. 3-1, FIG. 3-2, and FIG. 3-3. The typical filter frame top (2) shown has the mechanical latches (5) on one side and hinges (7) on the other side. This allows the filter frame top to open by swinging on the hinges (7) and be mechanically latched with the latch (5).

The frame top (2) has a horizontal rib (8) which carries the set of strike plates (4) for the magnetic closure of the filter frame prior to latching it closed. The horizontal rib has a clearance hole (6) for the inlet tube of the differential pressure sensor. The sensor clearance hole (6) is shown as a cut out on the horizontal rib of the Filter frame top (2). The standard cut out on the filter is aligned to the location of the strike plate and differential sensor hole. Top cross bars (9) are provided on the filter frame top (2) to provide additional support to the filter element (1) during operation.

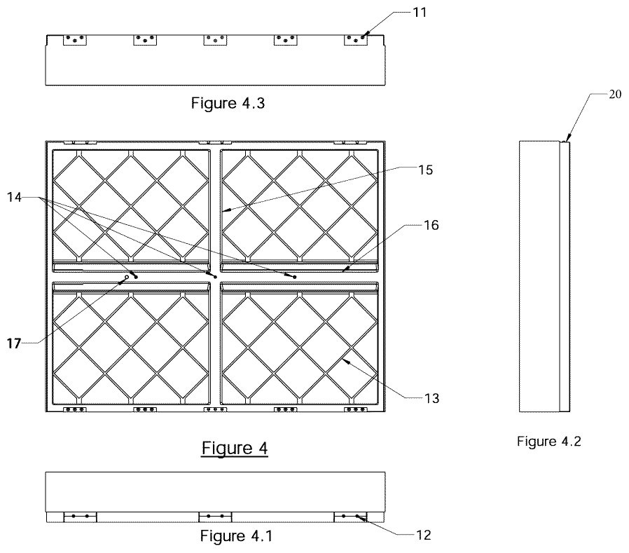

FIG. 4 shows the details of a filter frame bottom (3). The side views of the filter frame bottom are shown as 4-1, 4-2 and 4-3 respectively. The views of filter frame bottom (3) show the latch snap (12) that allows the latches (5) to mechanically close and latch the filter frame top to the filter frame bottom. The filter fame bottom (3) views also show the position of the hinge snaps (11) where the hinges (7) on the filter frame top (2) attach to the filter frame bottom (3) enabling the filter frame top to swing open when the latches are opened.

As shown, the typical filter frame bottom (3) is segmented into multiple segments by a central horizontal divider (16) and one or more vertical dividers (15) that help segment the filter frame bottom (3) into four or more segments, each segment enabled to hold one filter element/panel (1) securely within the segment. When the filter is closed and latched the horizontal divider (16) and the vertical dividers (15) of the filter frame bottom (3) compresses the edges of the filter element/panel (1) against the horizontal rib (8) and the vertical rib (10) on the filter frame top (2). This prevents the air from leaking around the filter element during operation.

The horizontal divider (16) also holds magnets (14) that couple with the magnetic strike plates (4) of the filter frame top (2) and allows the filter frame to be held closed with filters after filter replacement, enabling latching and closure of the filter frame. The horizontal rib also has a hole (17) matching the location of the filter frame top sensor clearance hole (6) for the input manifold of the differential pressure sensor.

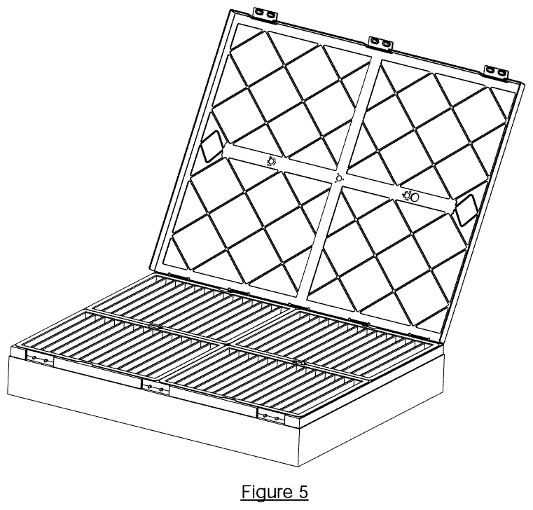

FIG. 5 shows the filter frame in an open state with the latches (5) disengaged from the latch snaps (12) and the top supported by the hinges fixed to the other side of the filter frame. The filter elements/panels (1) are shown loaded into the four segments of the typical filter frame bottom (3).

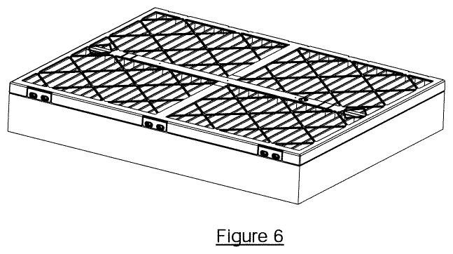

FIG. 6 shows the closed and latched filter frame with the filter frame top (2) latched to filter frame bottom (3) and with filter elements/panels (1) enclosed inside.

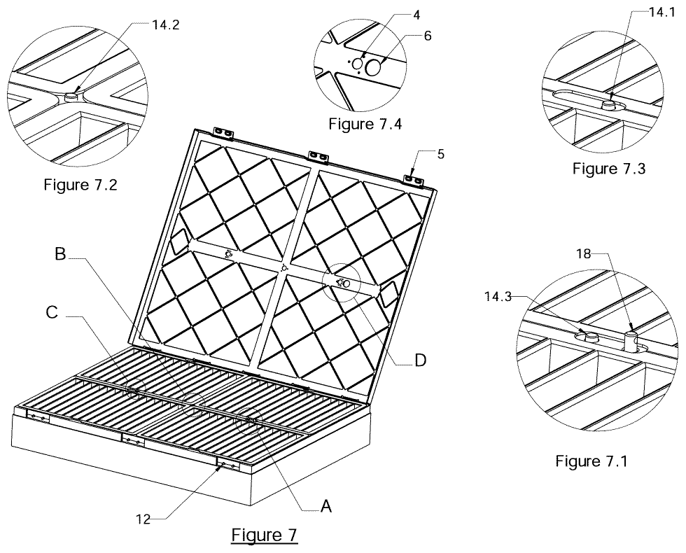

FIG. 7 shows the placement details of the three magnets (14-1, 14-2 and 14-3) placed at left, center and right of the horizontal divider (16) at locations A, (FIG. 7-1) B (FIG. 7-2) and C (FIG. 7-3). FIG. 7 also shows the differential sensor manifold input on the horizontal divider or horizontal rib (16) of the filter frame bottom (3) adjacent the magnet at location C as well as the details of the clearance hole (6) at location D (FIG. 7-4) adjacent the strike plate (4) for the differential sensor manifold on the filter frame top (2).

The clearance around the differential sensor intake is provided to reduce any turbulence that may impact the pressure measurements during operation of the filter system.

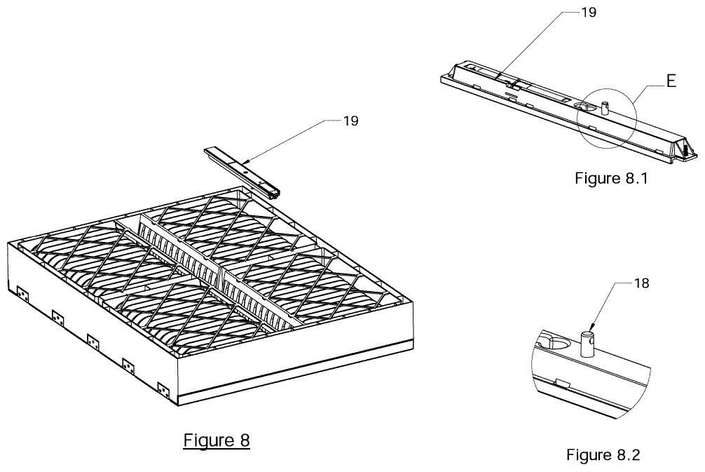

FIG. 8 shows the attachment of the communication module (19) and differential pressure sensing manifold (18) within a single module (FIG. 8-1) attached to the horizontal rib (16) of the filter frame bottom (3). The typical communication module (19) is enabled to communicate with the sensors either via a physical wire communication or typically over Bluetooth. The communication module further able to communicate over connected WiFi to inform the consumer of the need to change filter elements/panels due to due to increasing pressure differential across the filter indicative of the degradation of the filtering and air quality. The communication module may communicate with an external system having storage device to store sensor data.

FIG. 8 further shows the high-pressure side of the sensor intake of the sensor manifold (18) projecting out into the intake flow through the sensor clearance hole on the filter frame top (2). The projection and the clearance around the manifold reducing the turbulence of air at the intake to provide a more consistent and reliable differential pressure reading.

The communication module may further contain other sensors and power module (not shown in figures currently) that turns on and turns off the sensors and communication modules when the filter system is not operating to save power.

The standardized cut outs on the filter element/panel (1) are indented to allow the closure magnets (14) on the horizontal divider (16) of the filter frame bottom (3) to directly contact the strike plates providing sufficient closure strength to keep the filter frame closed before the mechanical latch components (5 and 12) are engaged to firmly close the filter frame. The standardized cutouts also enable the differential pressure manifold intake tube to project into the high-pressure air column through the sensor clearance hole (6) on the horizontal rib (8) of the filter frame top (2).

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A stackable air filter element comprising:
a filter material having central surface area in a pleated pattern; and
edges on the sides of the central surface area allowing the filter element to be supported by a filter frame; and
wherein the pleated pattern is configured to be aligned with the pleated pattern of another air filter element to allow stacking of the air filter element with the another air filter element.

2. The air filter element of claim 1 comprising at least one cutout, wherein the at least one cutout is configured to be aligned with a magnetic closure system of the filter frame.

3. The air filter element of claim 2, wherein the at least the cutout is configured to be aligned with an opening of a differential pressure sensor system of the filter frame.

4. The air filter element of claim 1, wherein the edges of the filter element engage with the filter frame to support the filter element and create a seal against air leaks when the filter element is inserted within the filter frame and the filter frame is latched closed.

5. A reusable air filter frame comprising:
a filter frame bottom defined by a plurality of support sections that are enabled to hold a replacement filter element in place within the filter frame bottom; and
a filter frame top connected by hinges to one of the plurality of support sections on one side of the filter bottom, wherein the filter frame top is enabled to be closed and latched to another of the plurality of support sections on the opposite side of the filter frame bottom to close the reusable air filter frame with the replaceable filter element within the reusable filter frame.

6. The reusable filter frame of claim 5, wherein the replaceable filter element within the closed and latched reusable filter frame is supported on all sides by the plurality of support sections of the filter frame bottom.

7. The reusable filter frame of claim 6, wherein the latched closed filter frame is enabled to create an airtight seal around the replaceable filter element within the filter frame.

8. The reusable filter frame of claim 5, wherein the plurality of support sections of the filter frame bottom comprise at least a horizontal divider or rib and at least a vertical divider.

9. The reusable filter frame of claim 8, wherein the replaceable filter element includes filter folds that are configured to be supported from distortion during use by additional support elements attached to the filter frame bottom.

10. The reusable filter frame of claim 5, wherein a depth of the filter frame bottom is configured to be the same depth of the replaceable filter element inserted therein.

11. The reusable filter frame of claim 5, wherein the reusable filter frame is configured to hold one or more replaceable filter elements during use.

12. The reusable filter frame of claim 5, wherein the filter frame is configured to hold a plurality of sensors, at least one control module, and at least one communication module, wherein the communication module is communicably coupled to the sensors, and wherein the communication module is connected to an external communication system.

13. The reusable filter frame of claim 12, wherein the plurality of sensors comprise a differential pressure sensor affixed to one of the plurality of supports of the frame bottom, wherein the differential pressure sensor is enabled to sense a filtered air pressure at an outlet of an air filter, and wherein the filter frame further comprises a manifold extending into the incoming air stream enabled to sense the air pressure at an inlet to the air filter to arrive at a differential pressure for air of the filter.

14. The reusable filter frame of claim 12, wherein the plurality of sensors further comprise at least an air temperature sensor and at least an air humidity sensor.

15. The reusable filter frame of claim 14, wherein the air temperature sensor enables a control of the filtered air temperature by an HVAC system using the air filter.

16. The reusable filter frame of claim 14, wherein the air humidity sensor enables a control of the filtered air humidity by an HVAC system using the air filter.

17. The reusable filter frame of claim 13, wherein the differential pressure sensor and the controller together are enabled to set an initial baseline differential pressure for the air filter each time the replaceable filter element is replaced in the reusable filter frame.

18. The reusable filter frame of claim 17, wherein the communication module is enabled to indicate the requirement for a filter element change to a consumer based on the differential air pressure change of the air filter.

19. The reusable filter frame of claim 13, wherein the communication module is enabled to provide air quality data external to the air filter for data storage.

20. A reusable air filter system, the system comprising:
a replaceable air filter element being a stackable filter element having a plurality of pleated folds in a central region; and having edges around the central region enabled to support the replaceable filter element within the reusable air filter frame; wherein a pleated fold of a first replaceable filter element is configured to align with the pleated fold pattern of another replaceable filter element, enabling stacking of the replaceable filter elements for storage and shipping; and
a reusable air filter frame comprising:
a closable and latchable bottom section and a top section; the closed and latched reusable filter frame enabled to hold the replaceable filter elements securely therein and provide an air tight seal around the replaceable filter element during operation of the filter system;
a plurality of sensors including a differential air pressure sensor, an air temperature sensor, and an air humidity sensor;
a communication module enabled to provide at least a disposable filter replacement indication and an air quality information to a consumer and a storage device; and
a control module enabled to generate a base line differential pressure value for a replaced disposable filter and generate a replacement indication for the disposable filter based on differential pressure change that is provided to the consumer.
